(19) United States
(12) Patent Application Publication
(10) Pub. No.: US 2001/0049643 A1
(43) Pub. Date: Dec. 6, 2001

(54) System for preferred location pick-up for electronically purchased items

(76) Inventor: Bruce R. Davis, Woodland Hills, CA (US)

Correspondence Address: Roger A. Marrs, Suite 1120, 15233 Ventura Blvd., Sherman Oaks, CA, 91403, US

(21) Appl. No.: 09/803,787

(22) Filed: Mar. 12, 2001

Related U.S. Application Data
(60) Provisional application No. 60/188,770, filed on Mar. 13, 2000.

(51) Int. Cl. G06F 17/60

(52) U.S. Cl. 705/27

(57) ABSTRACT

A system for electronic business transactions enabling purchases in an online environment to be picked up locally. Participating merchant(s) manipulate the particulars of products offered such as price, quantity available and time allotted each offer. The purchaser views products via server generated web pages. Merchants manipulate particulars of said products via web pages within the network which allow specific particulars to be editable by said merchant and displayed to the potential purchaser. The potential purchaser enters a locality identifier such as zip code to retrieve options from involved merchants for purchase and then pick up in the preferred locality. An interactive electronic environment is created.

### BACKGROUND OF THE INVENTION

1. Field of the Invention

This invention relates to the field of electronic business systems and, more particularly, to a purchasing and delivery system utilizing a computer or similar device which allows for product information to be manipulated, scrutinized and purchased electronically while being available for local physical retrieval or pick-up.

2. Brief Description of the Prior Art

It is a conventional practice to employ electronic equipment such as a computer for purchasing products, services or the like online via a display of web pages. Also, the concept of competitive and comparative shopping is a widely known practice.

However, problems and difficulties have been encountered with conventional practices of electronic product selection and purchase which stems from the lack of real time product manipulation or variance comparison by multiple users. Also shipping and handling charges are necessary in order to deliver the selected and purchased product to the purchaser.

Therefore, a long-standing need has existed to provide an electronic purchasing and delivery system whereby the seller or server may selectively vary the pricing of an article or service for competitive purposes and further provide for a local retrieval or local delivery of the electronically purchased articles or services. This purchasing and delivery service should be possible via an electronic network of servers set up to perform these transactions in a sequential order.

### SUMMARY OF THE INVENTION

An embodiment of the present invention provides an electronic method and system via computer or similar device which allows for products to be manipulated, scrutinized and purchased electronically yet available for local physical retrieval. This is possible via an electronic network of servers set up to do these applications and transactions in a sequential order permitting participating merchants to manipulate particular and specific properties of products offered through a web site. The merchants, in effect, compete in real time to entice the potential purchaser to buy it's particular terms. At the same time the potential purchaser is able to compare terms and locations and then purchase the product or service based upon accepted terms while the terms exist, followed by picking up that product locally or at a convenient physical location of choice. A secure method of purchase confirmation is also interwoven into this system.

Therefore, it is among the primary objects of the present invention to provide an electronic purchasing system which permits the server or multiple servers to compete online in real time to gain a potential customer's purchase as well as to offer local product pick-up.

Another object resides in providing an interactive electronic environment whereby a potential purchaser may be enticed by a seller who has the electronic capability to adjust for price, pick-up location, terms and conditions, etc. in order to compete with other sellers of the same product on a real time basis to gain the potential purchaser's business.

Still a further object resides in providing an electronic purchasing and delivery system permitting a merchant to compete in real time against other merchants in order to entice a potential customer to buy a product or service at the merchant's changeable terms and conditions.

### BRIEF DESCRIPTION OF THE DRAWING

The features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a block schematic drawing illustrating the flow of electronic information employed in the server network incorporating the present invention.

### DESCRIPTION OF PREFERRED EMBODIMENT

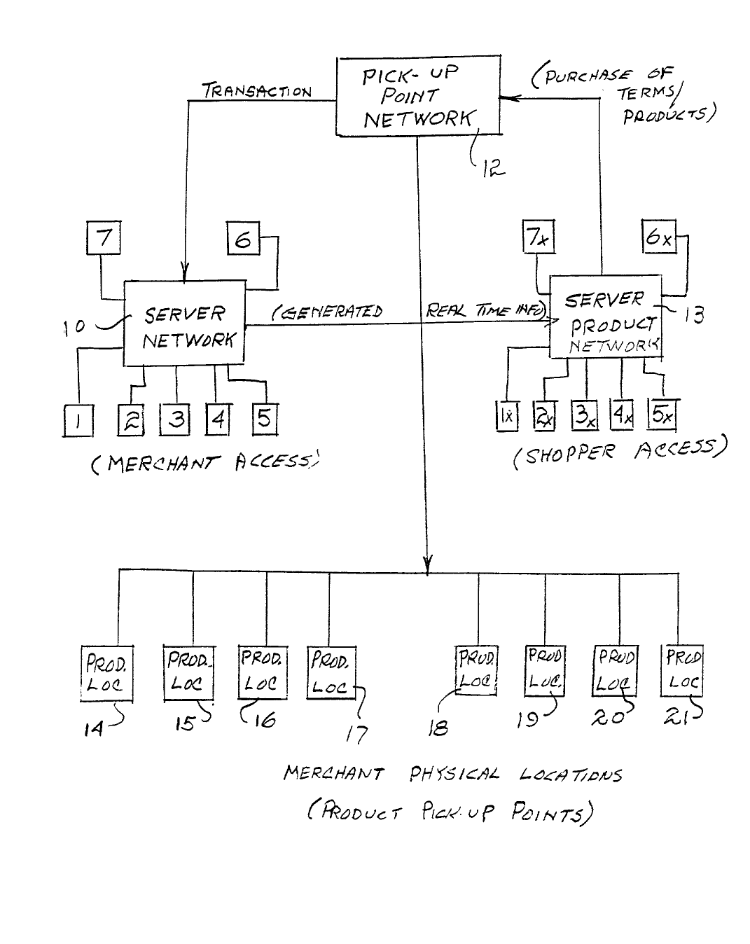

A server network in accordance with the present invention is illustrated in the description of FIG. 1 which presents a system wherein merchants or seller offer a pre-approved listing of products available to general public customers via electronic selection on a web site. Selected product particulars and merchant of choice is reviewed and the resultant purchase product is available at the chosen merchants local site for personal inspection and pick-up.

Each server 10 includes merchants 1-7 inclusive and each merchant has an identifier password or other secure measure of protective Internet access to its account. Each server includes electronic folders for all the products the merchant is promoting on a web site. Each folder also contains transaction information generated by activity of sales on the web site and other information pertaining to each account. Each merchant 1-7 has the capability and opportunity of changing prices, quantity, and dedicated time allotted for a particular promotion involving a particular product in real time. When a potential shopper, buyer or purchaser 1X-7X inclusive visits the web site, a variety of headings are displayed from which the shopper, buyer or purchaser can choose to shop or browse for products. When a heading is chosen, the potential buyer or shopper will be sent to a page or pages, via link, containing the products of interest. Each product has its own search box whereby the potential buyer or shopper can input their zip code or other locality identifier so that the system returns the location within or near the locality that are a part of the network and have that product. The pick-up point network is identified by numeral 12 and the server for products is indicated by numeral 13. This display by multiple merchants within the network has changeable particulars whereby a merchant can negotiate or change those particulars in real time in order to entice a potential buyer or shopper to purchase those items of interest. Then, the shopper, after successful purchase of a particular item or items, can pick-up the purchased products from a location 14-21 inclusive under the agreed upon terms and conditions which were purchased on the web site.

When a purchase of terms and products is made on the web site, an e-mail confirmation is sent to the successful purchaser or buyer, the merchant and to a pick-up point network 12 administrative division. The confirmation contains the particulars of the transaction such as product identifiers, locality identifiers, price, quantity, time allotments, buyer ID and credit information and password for the purchase (which is not on the buyer's confirmation). This information can also be downloaded to a debit card which can be presented at the pick-up point 14-21 inclusive to retrieve purchased product. At the pick-up point, the purchaser must present identification such as an ID Card, the e-mail confirmation or debit card containing the information and the purchaser must know the password which they choose for that particular product. Upon satisfaction of the aforementioned procedure, the product is then presented to the purchaser at the selected pick-up point 14-21 selected by the purchaser.

While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention.

What is claimed is:

1. A method for electronic purchasing and pick-up procedures comprising the steps of:
organizing a merchant server network providing electronic access thereto by a plurality of participating merchants offering pre-approved products for purchase;
manipulating the particulars of the pre-approved products offered such as price, quantity available and time allotted each offer;
establishing a purchaser server network electronically coupled to the merchant server network for real time information communication providing terms and conditions of purchase;
viewing of the terms and conditions via the purchaser server network by a potential purchaser;
said manipulating step including allowing specific particulars to be editable by the participating merchants whereby resultant terms and conditions are viewed by the potential purchaser;
establishing a product pick-up network in electronic communication with a plurality of separately located product pick-up locations; and
completing a purchase transaction by the purchaser entering a locality identifier to retrieve options from participating merchants for payment and pick-up in the preferred locality.

2. The method defined in claim 1 wherein:
said organizing step includes establishing a merchant ID by coded password for an Internet file protection in real time.

3. The method defined in claim 2 wherein:
said completing step includes releasing selected pre-approved product to the purchaser upon presentation of identifying password, ID form and e-mail receipt in order to match the purchaser with the selected pre-approved product, purchase transactions and participating merchant.

4. The method defined in claim 3 wherein:
said establishing step for a product pick-up network further includes reception of purchased terms and conditions from the purchaser via the server product network and for handling the purchase transaction with the participating merchants before communicating the transaction to the pick-up location.

5. The method defined in claim 4 wherein:
said establishing of the purchaser server network includes display of individual product search box interrogated by potential purchaser employing zip code identifier.

6. The method defined in claim 5 including the step of:
generating a results page derived from a web page showing a choice of merchants having the pre-approved product near the zip code identifier.
